(19) United States
(12) Patent Application Publication
(10) Pub. No.: US 2017/0031291 A1
(43) Pub. Date: Feb. 2, 2017

(54) SHEET CASSETTE AND IMAGING FORMING APPARATUS PROVIDED WITH SAME

(71) Applicant: KYOCERA Document Solutions Inc., Osaka (JP)

(72) Inventor: Nobuhiro Nishioka, Osaka-shi (JP)

(21) Appl. No.: 15/212,324

(22) Filed: Jul. 18, 2016

(30) Foreign Application Priority Data
Jul. 27, 2015 (JP) 2015-147530

(51) Int. Cl. G03G 15/00; B65H 1/04; B65H 1/08

(52) U.S. Cl. CPC G03G 15/6502; B65H 1/08; B65H 1/04

(57) ABSTRACT

A sheet cassette includes a bottom portion, a pair of side walls, a lift plate and an auxiliary supporting portion. The pair of side walls stand from the bottom portion. The lift plate is arranged on the bottom portion, and a sheet to be fed in a conveying direction is placed on the upper surface of the lift plate. The lift plate includes a pair of fulcrum portions arranged on an upstream side in the conveying direction and is moved to a sheet feeding position for feeding the sheet by being moved upward from a bottom position with the fulcrum portions. The auxiliary supporting portion is arranged inwardly of the pair of fulcrum portions in a sheet width direction, is arranged between the lift plate arranged at the bottom position and the bottom portion and supports the lift plate.

This application is based on Japanese Patent Application No. 2015-147530 filed with the

Japan Patent Office on Jul. 27, 2015, the contents of which are hereby incorporated by reference.

### BACKGROUND

The present disclosure relates to a sheet cassette and an image forming apparatus provided with the same.

Conventionally, a sheet cassette provided in an image forming apparatus is known as the one in which sheets are stacked. The sheet cassette is mountable along a predetermined direction into an apparatus main body of an image forming apparatus. The sheet cassette includes a lift plate for pushing up downstream sides of sheets in a conveying direction. The lift plate includes a pair of fulcrum portions arranged on an upstream side in the sheet conveying direction. The lift plate is swung about the fulcrum portions, whereby the sheets are pushed upwardly. The fulcrum portions of the lift plate are provided on opposite end parts in a sheet width direction.

### SUMMARY

A sheet cassette according to one aspect of the present disclosure includes a bottom portion, a pair of side walls, a lift plate and at least one auxiliary supporting portion. The pair of side walls stand from the bottom portion to face each other. The lift plate is arranged on the bottom portion, and a sheet to be fed in a conveying direction along the side walls is placed on the upper surface of the lift plate. The lift plate includes a pair of fulcrum portions respectively arranged on an upstream side in the conveying direction and supported on the side walls. The downstream side of the lift plate moves swingably in the vertical direction with the fulcrum portion. The lift plate is moved to a sheet feeding position for feeding the sheet moved upwardly from a bottom position where the lift plate extends along the bottom portion with the fulcrum portions. The auxiliary supporting portion is arranged inwardly of the pair of fulcrum portions in a sheet width direction perpendicular to the conveying direction, is arranged between the lift plate at the bottom position and the bottom portion and supports the lift plate.

Further, an imaging forming apparatus according to another aspect of the present disclosure includes the above sheet cassette and an image forming unit. The image forming unit forms an image on the sheet fed from the sheet cassette.

### BRIEF DESCRIPTION OF THE DRAWINGS

FIG. 1 is a sectional view of an image forming apparatus according to one embodiment of the present disclosure.

FIG. 2 is a perspective view of a sheet cassette according to the one embodiment of the present disclosure.

FIG. 3 is a plan view of the sheet cassette according to the one embodiment of the present disclosure.

FIG. 4 is a plan view of the sheet cassette with a lift plate removed from a state of FIG. 3.

FIG. 5A is a perspective view of the lift plate according to the one embodiment of the present disclosure.

FIG. 5B is a perspective view of the lift plate according to the one embodiment of the present disclosure.

FIG. 6 is an enlarged plan view of a part of the sheet cassette according to the one embodiment of the present disclosure.

FIG. 7 is an enlarged side view of the part of the sheet cassette according to the one embodiment of the present disclosure.

FIG. 8 is an enlarged side view of a part of a sheet cassette according to a modification of the present disclosure.

### DETAILED DESCRIPTION

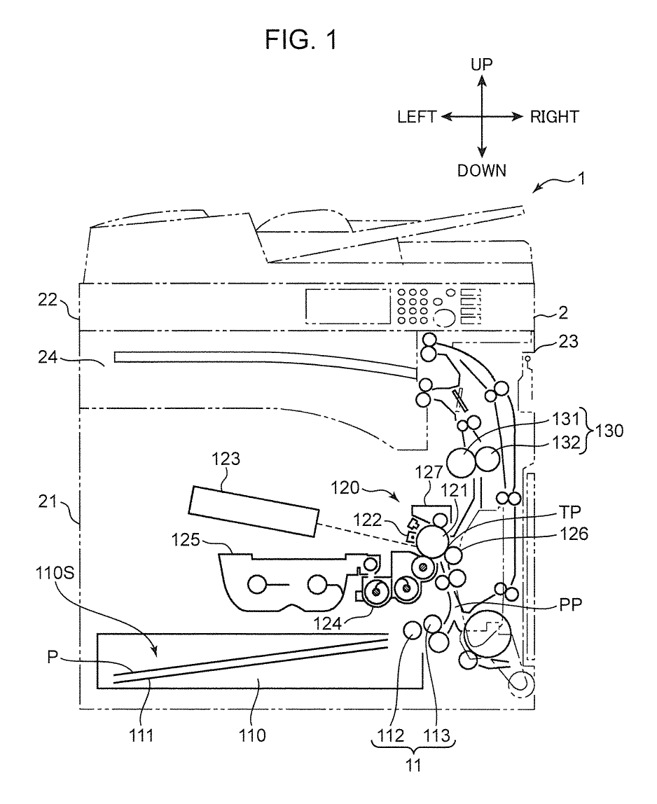

Hereinafter, one embodiment of the present disclosure is described with reference to the drawings. FIG. 1 is an internal sectional view of an image forming apparatus 1 according to the one embodiment of the present disclosure. The image forming apparatus 1 shown in FIG. 1 is a so-called monochrome printer. In other embodiments, the image forming apparatus may be a color printer, a facsimile machine, a complex machine provided with these functions or another apparatus for forming a toner image on a sheet. Note that direction-indicating terms such as “upper” and “lower”, “front” and “back”, “left” and “right” used in the following description are merely for the purpose of clarifying the description and do not limit the principle of the image forming apparatus at all. Further, in the following description, a term “sheet” means a copy sheet, a coated paper, an OHP sheet, a cardboard, a postcard, a tracing paper or another sheet material to which an image forming process is to be applied or another sheet material to which an arbitrary process other than the image forming process is to be applied.

The image forming apparatus 1 includes a substantially rectangular parallelepipedic main housing 2. The main housing 2 includes a substantially rectangular parallelepipedic lower housing 21, a substantially rectangular parallelepipedic upper housing 22 arranged above the lower housing 21 and a coupling housing 23 coupling the lower housing 21 and the upper housing 22. A sheet having a printing process applied thereto is discharged to a discharge space 24 enclosed by the lower housing 21, the upper housing 22 and the coupling housing 23.

The image forming apparatus 1 includes a sheet cassette 110, a sheet feeding unit 11 and an image forming unit 120. The sheet feeding unit 11 includes a pickup roller 112 and a sheet feed roller 113. The sheet feeding unit 11 feeds a sheet P in a rightward direction (conveying direction) from the sheet cassette 110 to a sheet conveyance path PP. The sheet conveyance path PP is a conveyance path arranged to extend from the sheet feeding unit 11 and pass through a transfer position TP arranged in the image forming unit 120.

The sheet cassette 110 can be pulled out in a forward direction (direction forward of the plane of FIG. 1) from the lower housing 21 and mounted into the lower housing 21 along a backward direction (predetermined mounting direction). The sheet cassette 110 includes a lift plate 111. A bundle of sheets P is placed on a cassette bottom portion 110T and the lift plate 111. The lift plate 111 is inclined to push up the leading edges of the sheets P.

The pickup roller 112 is arranged above the leading edges of the sheets P pushed upward by the lift plate 111. When the pickup roller 112 rotates, the sheet P is pulled out from the sheet cassette 110. Note that the sheet P is fed in a sheet feeding direction (rightward direction) intersecting with the mounting direction of the sheet cassette 110 in the lower housing 21. The sheet feed roller 113 is arranged downstream of the pickup roller 112 in the sheet conveying direction. The sheet feed roller 113 feeds the sheet P further toward a downstream side in the sheet conveying direction.

The image forming unit 120 forms an image on the sheet P fed from the sheet cassette 110. The image forming unit 120 includes a photoconductive drum 121, a charger 122, an exposure device 123, a developing device 124, a toner container 125, a transfer roller 126 and a cleaning device 127.

The image forming apparatus 1 further includes a fixing device 130 arranged downstream of the image forming unit 120 in the conveying direction and configured to fix a toner image on the sheet P. The fixing device 130 includes a heating roller 131 for melting toner on the sheet P and a pressure roller 132 for bringing the sheet P into close contact with the heating roller 131.

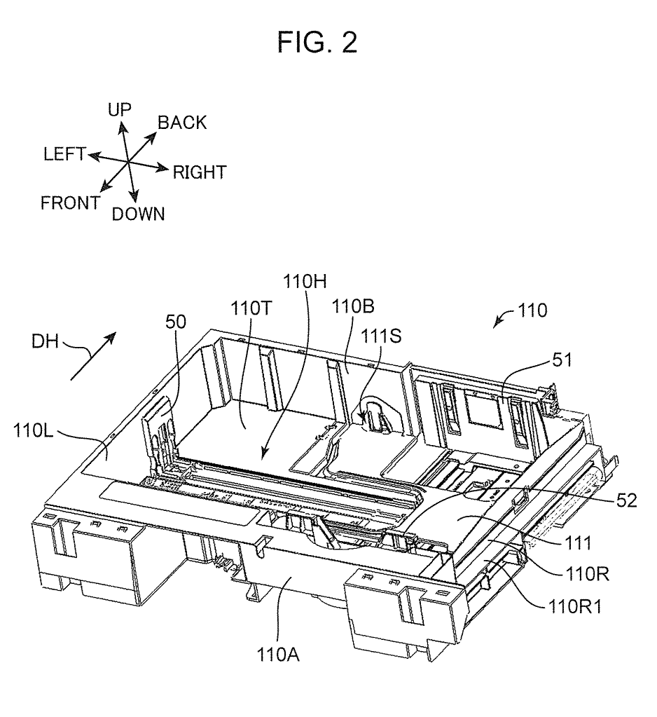

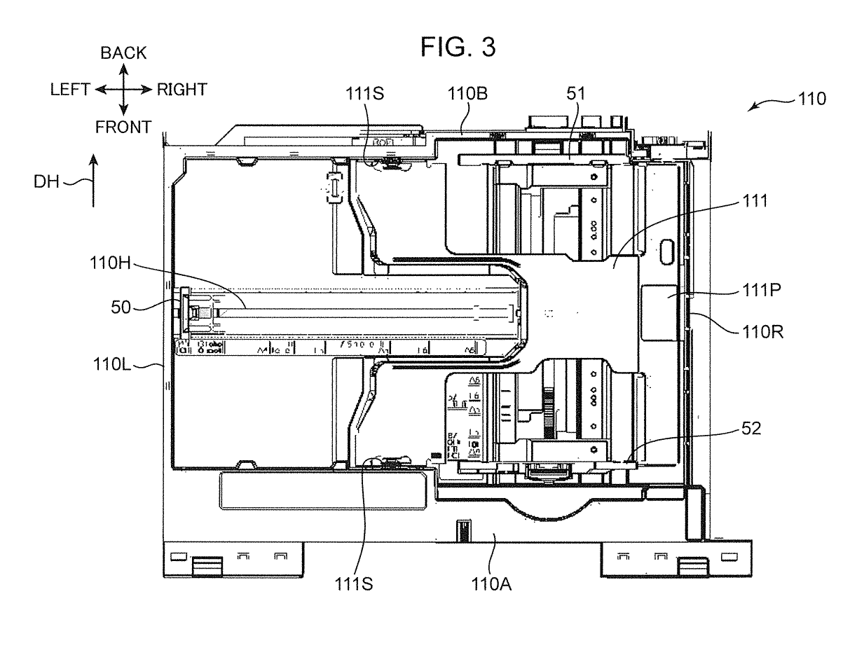

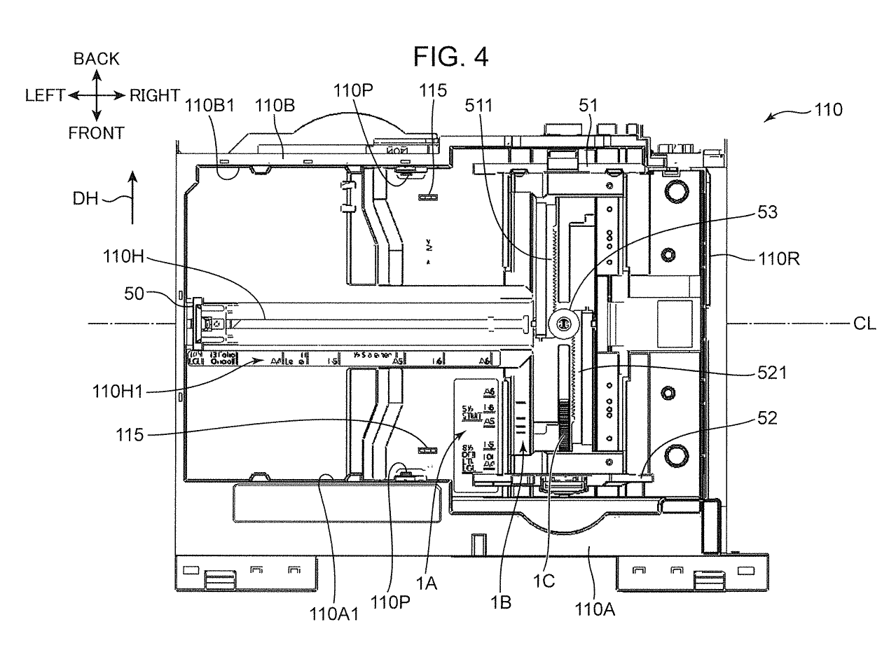

Next, the sheet cassette 110 according to this embodiment is described in more detail. FIG. 2 is a perspective view of the sheet cassette 110 according to this embodiment. FIG. 3 is a plan view of the sheet cassette 110. FIG. 4 is a plan view of the sheet cassette 110 with the lift plate 111 removed from a state of FIG. 3.

With reference to FIG. 2, the sheet cassette 110 has a substantially rectangular parallelepipedic shape and the upper surface is open. The sheet cassette 110 includes the cassette bottom portion 110T (bottom portion), a cassette front wall 110A, a cassette rear wall 110B, a cassette right wall 110R and a cassette left wall 110L. The cassette bottom portion 110T is a bottom part of the sheet cassette 110 and has a rectangular shape in a plan view. The cassette front wall 110A, the cassette rear wall 110B, the cassette left wall 110L and the cassette right wall 110R stand up from front, rear, left and right side parts of the cassette bottom portion 110T. As a result, a sheet storage portion 110S (FIG. 1) is formed in the sheet cassette 110 and the sheets P are stored. Note that the cassette front wall 110A and the cassette rear wall 110B (a pair of side walls) extending in a lateral direction stand up from the cassette bottom portion 110T to face each other. In this embodiment, the cassette bottom portion 110T, the cassette front wall 110A, the cassette rear wall 110B, the cassette right wall 110R and the cassette left wall 110L are integrally molded (integral structure) by resin molding. Note that the sheets P are conveyed in the conveying direction along the cassette front wall 110A and the cassette rear wall 110B.

Further, in FIG. 2, an unillustrated cassette cover is mounted in front of the cassette front wall 110A. Further, the cassette right wall 110R includes a right rail 110R1. Similarly, the cassette left wall 110L also includes an unillustrated left rail. These rails guide the mounting of the sheet cassette 110 into the lower housing 21. At this time, the sheet cassette 110 is mounted into the lower housing 21 in a direction of an arrow DH of FIGS. 2 and 3.

Further, the aforementioned lift plate 111 is a plate-like member arranged on the cassette bottom portion 110T. The lift plate 111 is swingable with cassette shaft supporting portions 110P (FIG. 4) provided on the cassette front wall 110A and the cassette rear wall 110B as a fulcrum. Lift plate fulcrum portions 111S (FIGS. 2, and 3) of the lift plate 111 are inserted through the cassette shaft supporting portions 110P. Further, the lift plate 111 includes a pad member 111P (FIG. 3). The pad member 111P is an elastic member bonded to a right end part of the lift plate 111. The pad member 111P prevents the slip of the sheets P.

The sheet cassette 110 further includes a trailing-end cursor 50 and a trailing-end guide portion 110H (FIG. 2). The trailing-end cursor 50 regulates trailing end parts of the sheets stored in the sheet storage portion 110S in the conveying direction. The trailing-end guide portion 110H is a guide groove extending in the lateral direction on the cassette bottom portion 110T. The trailing-end cursor 50 is movable in the conveying direction of the sheet P along the trailing-end guide portion 110H. A trailing-end size indicator 110H1 indicating the sizes of the sheets P is arranged at a front side of the trailing-end guide portion 110H (FIG. 4).

Further, the sheet cassette 110 includes a first cursor 51, a second cursor 52 and a pinion gear 53 (FIG. 4). The first cursor 51 is movable along the mounting direction of the sheet cassette 110 on the cassette bottom portion 110T and comes into contact with the leading end edges of the sheets P in the conveying direction. Similarly, the second cursor 52 is movable along the mounting direction on the cassette bottom portion 110T and comes into contact with the trailing end edges of the sheets P in the mounting direction.

The first cursor 51 includes a first rack 511. Further, the second cursor 52 includes a second rack 521. The first and second racks 511, 521 respectively extend inwardly in the width direction of the sheets P from the first and second cursors 51, 52. The first and second racks 511, 512 include a rack gear. These rack gears are engaged with the pinion gear 53 rotatably arranged between the first and second cursors 51, 52. As a result, the first and second cursors 51, 52 are interlocked with each other and slidable in the width direction (front-back direction) of the sheets P.

With reference to FIG. 4, the sheet cassette 110 includes a size indicator 1A, a regular size groove portion 1B and a fixing rack 1C. A plurality of sizes of the sheets P are indicated on the size indicator 1A. When the second cursor 52 is moved in the front-back direction, one end of the second cursor 52 indicates one sheet size of the size indicator 1A. As a result, the size of the sheets P storable in the sheet storage portion 110S is recognized by a user.

The regular size groove portion 1B includes a plurality of grooves arranged at intervals in the front-back direction at a right side of the size indicator 1A. Each of these grooves has a predetermined length in the lateral direction and is formed by recessing a part of the cassette bottom portion 110T. The arrival of the second cursor 52 at a predetermined position is recognized by the user by click feeling given when an unillustrated projecting piece projecting from the second cursor 52 is inserted into the groove of the regular size groove portion 1B.

The fixing rack 1C is arranged to extend in the front-back direction at a right side of the regular size groove portion 1B on the cassette bottom portion 110T. The fixing rack 1C includes a plurality of gear teeth formed at intervals in the front-back direction (mounting direction). The fixing rack 1C has a function of fixing the position of the second cursor 52 in the front-back direction. An unillustrated engaging projection projecting downward from the second cursor 52 is engaged with the gear teeth of the fixing rack 1C, whereby the position of the second cursor 52 is locked. Note that the first and second cursors 51, 52 integrally move via the pinion gear 53 as described above. Thus, if the position of the second cursor 52 is fixed by the fixing rack 1C, the position of the first cursor 51 is naturally fixed.

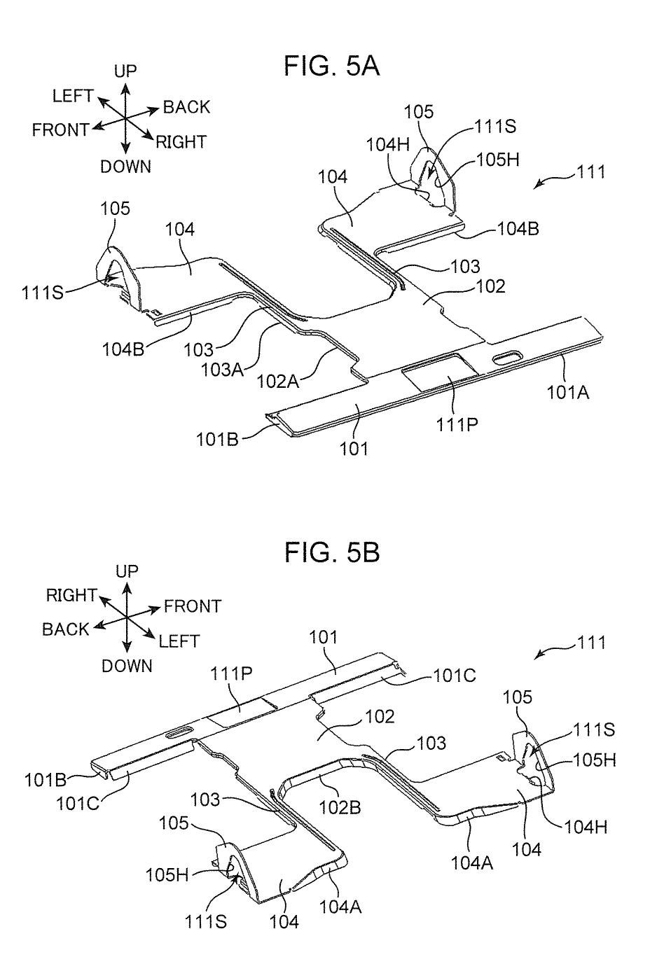

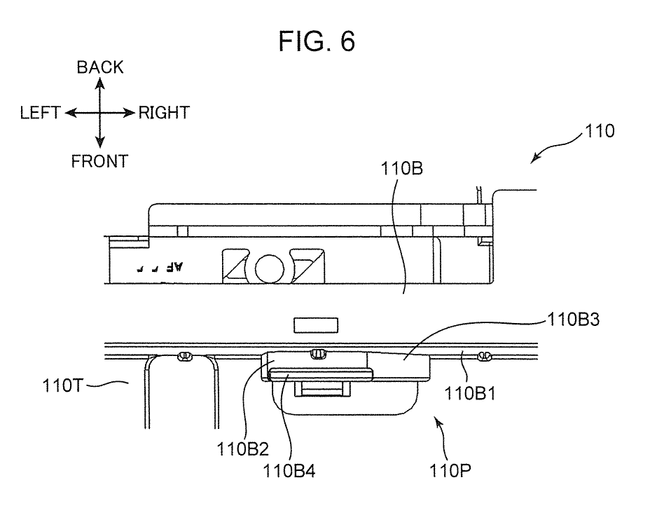

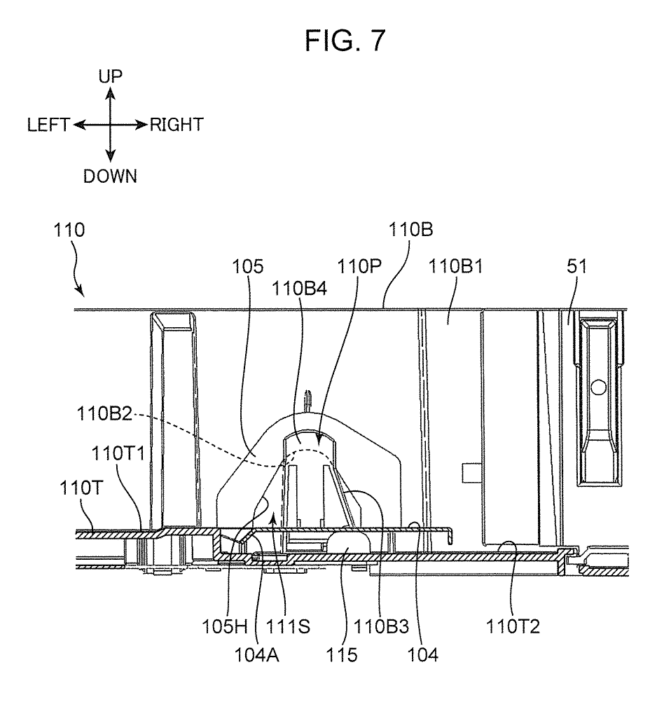

FIGS. 5A and 5B are perspective views of the lift plate 111 according to this embodiment. FIG. 6 is an enlarged plan view of a part of the sheet cassette 110 according to this embodiment around the cassette shaft supporting portion 110P on the side of the cassette rear wall 110B. Similarly, FIG. 7 is an enlarged side view of the part of the sheet cassette 110 around the cassette shaft supporting portion 110P on the side of the cassette rear wall 110B.

With reference to FIGS. 5A and 5B, the lift plate 111 includes a tip portion 101, a central portion 102, a pair of coupling portions 103, a pair of rear end portions 104 (planar portions) and a pair of standing wall portions 105. The lift plate 111 is formed of an integral metal plate member. The tip portion 101 is arranged on a tip side of the lift plate 111 in the conveying direction of the sheets P. The tip portion 101 extends to be long and narrow in the front-back direction and the aforementioned pad member 111P is bonded to a central part of the tip portion 101. The central portion 102 is a substantially rectangular area connected to a central part of the tip portion 101 in the front-back direction. The pair of coupling portions 103 are arranged to extend in a leftward direction (toward an upstream side in the conveying direction of the sheets P) from front and rear edges of the central portion 102. The rear end portions 104 are respectively connected to the pair of coupling portions 103. The rear end portions 104 have a substantially rectangular shape in a top view. The standing wall portions 105 stand up from front and rear end parts of the pair of rear end portions 104. An upper end side of the standing wall portion 105 has a substantially triangular shape in a front view.

By bending the peripheral edge of the lift plate 111 formed of a metal plate downwardly, the tip portion 101 includes a tip first rib 101A (FIG. 5A), a tip second rib 101B and a tip third rib 101C (FIG. 5B). Similarly, the central portion 102 includes a central first rib 102A (FIG. 5A) and a central second rib 102B (FIG. 5B). Further, the coupling portion 103 includes a coupling rib 103A. Further, the rear end portion 104 includes a rear-end first rib 104A extending in a sheet width direction and a rear-end second rib 104B. The rigidity of the lift plate 111 is improved by these ribs.

A standing wall opening 105H is open in the standing wall portion 105. The standing wall opening 105H is an opening having a substantially triangular shape in a front view. Note that an upper end part of the standing wall portion 105 has a moderate arc shape. On the other hand, the rear end portion 104 includes a rear-end opening 104H. The rear-end opening 104H is an opening open near a boundary of the rear end portion 104 with the standing wall portion 105 to communicate with a lower end part of the standing wall opening 105H. The lift plate fulcrum portion 111S (fulcrum portion) of the lift plate 111 is formed by the standing wall portion 105 including the standing wall opening 105H. The pair of lift plate fulcrum portions 1115 are arranged on an upstream side part of the lift plate 111 in the conveying direction of the sheets P and respectively swingably supported on the cassette shaft supporting portions 110P of the cassette front wall 110A and the cassette rear wall 110B.

With reference to FIGS. 6 and 7, the cassette rear wall 110B includes a rear inner wall portion 110B1. The rear inner wall portion 110B1 is an inner wall surface of the cassette rear wall 110B defining the sheet storage portion 110S. The cassette shaft supporting portion 110P (FIG. 6) swingably supporting the lift plate 111 projects from the rear inner wall portion 110B1. The cassette shaft supporting portion 110P includes a curved supporting portion 110B2, an inclined portion 110B3 and a pressing portion 110B4.

The curved supporting portion 110B2 (FIGS. 6 and 7) is a curved surface projecting forward from the rear inner wall portion 110B1 while having a predetermined width. The curved supporting portion 110B2 is formed by a substantially semi-cylindrical surface convex upward. The inclined portion 110B3 is an inclined surface connected to a right end part of the curved supporting portion 110B2 and inclined downwardly toward the right. Note that an unillustrated side surface extending substantially in a vertical direction is connected to a left end part of the curved supporting portion 110B2. The pressing portion 110B4 is a wall portion extending upward from a front end part of the curved supporting portion 110B2. The pressing portion 110B4 regulates the position of the standing wall portion 105 (FIG. 7) of the sheet cassette 110 pivotally supported on the cassette shaft supporting portion 110P in the front-back direction. Note that the cassette shaft supporting portion 110P (FIG. 4) on the side of the cassette front wall 110A also has the same configuration as described above.

With reference to FIGS. 5A to 7, the lift plate 111 is inserted into the sheet storage portion 110S of the sheet cassette 110 from above in assembling the sheet cassette 110. At this time, the standing wall portion 105 (FIG. 5A) is inserted into a clearance between the pressing portion 110B4 and the rear inner wall portion 110B1 while the pressing portion 110B4 of FIG. 6 passes through the rear-end opening 104H of FIG. 5A. Then, by the contact of an inner peripheral part of the standing wall portion 105 with the curved supporting portion 110B2 (FIGS. 6 and 7), the downstream side of the lift plate 111 moves swingably in the vertical direction with the cassette shaft supporting portion 110P. A bundle of sheets P is placed on the lift plate 111 with the lift plate 111 arranged at a bottom position where it extends along the cassette bottom portion 110T (FIG. 2).

When the sheet cassette 110 is mounted into the lower housing 21 (FIG. 1), a downstream side of the lift plate 111 in the conveying direction is moved upward from the bottom position with the cassette shaft supporting portions 110P as a fulcrum by an unillustrated driving mechanism including a drive motor and a gear train. Specifically, the sheet cassette 110 includes an unillustrated elevating mechanism for moving the lift plate 111 up and down. The elevating mechanism includes a rotary shaft coupled to the gear train of the driving mechanism and a contact piece radially projecting from this rotary shaft. The contact piece is located below the lift plate 111. When a rotational drive force is transmitted from the gear train and the contact piece rotates, the contact piece swings along the underside of the central portion 102 (FIG. 5A) of the lift plate 111, whereby the lift plate 111 is moved up and down. As a result, the lift plate 111 is moved to a sheet feeding position above the bottom position for feeding the sheet P. The uppermost sheet P of the bundle of the sheets P comes into contact with the pickup roller 112 (FIG. 1) and fed to the sheet conveyance path PP.

When the lift plate 111 is arranged at the sheet feeding position, the weight of the sheet bundle is continuously applied to the unillustrated gear train provided in the above driving mechanism. If an image forming operation is not performed for a fixed period to remove such a load and shut off energization to the drive motor, the lift plate 111 is moved to the bottom position again by the driving mechanism. When the lift plate 111 is arranged at the bottom position, the weight of the sheet bundle is applied to the curved supporting portions 110B2 (FIGS. 6 and 7) of the cassette shaft supporting portions 110P via the standing wall portions 105 of the lift plate 111. As described above, in this embodiment, the cassette bottom portion 110T, the cassette front wall 110A, the cassette rear wall 110B, the cassette right wall 110R and the cassette left wall 110L are integrally molded by resin molding. Thus, if a strong load is applied to the cassette shaft supporting portion 110P of the cassette rear wall 110B, the cassette rear wall 110B is easily inclined inwardly (forwardly) in the width direction of the sheets P (front-back direction). With reference to FIG. 6, a vertical movement of the lift plate 111 may be obstructed by the rubbing of the rear inner wall portion 110B1 and the standing wall portion 105 (FIG. 5A) if the cassette rear wall 110B is inclined forwardly.

Further, if the inclination of the cassette rear wall 110B is promoted, the cassette bottom portion 110T is easily deflected into a cylindrical surface such that a central part in the front-back direction projects downward. As described above, the trailing-end cursor 50 (FIG. 4) slides along the trailing-end guide portion 110H on a left side part of the cassette bottom portion 110T. Further, the first and second cursors 51, 52 slide in the front-back direction on a right side part of the cassette bottom portion 110T. The deflection of the cassette bottom portion 110T easily results in impaired functions of the sheet cassette 110 including movements of such cursors.

Furthermore, if an unillustrated cassette heater is provided on the periphery of the sheet cassette 110 for the purpose of dehumidifying the sheets P stored in the sheet cassette 110, the deformation of the sheet cassette 110 made of resin is further easily promoted by heat transferred from the heater and a load applied from the lift plate 111.

In this embodiment, the sheet cassette 110 includes supporting projections 115 (FIG. 7) (auxiliary supporting portion) to solve trouble associated with the deformation of the sheet cassette 110 as described above. The supporting projections 115 are provided between the cassette bottom portion 110T and the lift plate 111 of the sheet cassette 110. With reference to FIG. 7, the cassette bottom portion 110T of the sheet cassette 110 includes a first bottom portion 110T1 and a second bottom portion 110T2. The first bottom portion 110T1 is an upstream part of the cassette bottom portion 110T in the conveying direction and an area located to the left of the standing wall portions 105 of the lift plate 111. When the lift plate 111 is arranged at the bottom position, an upper surface part (rear end portions 104) of the lift plate 111 and that of the first bottom portion 110T1 are substantially flush with each other (FIG. 7). Then, the sheets P are stacked on the first bottom portion 110T1 and the lift plate 111. The second bottom portion 110T2 is an area arranged downstream of the first bottom portion 110T1 in the conveying direction and arranged to be lower than the first bottom portion 110T1 via a step. Note that the lift plate 111 is located on the second bottom portion 110T2. By the cassette bottom portion 110T including the step as just described, the lift plate 111 including a plurality of ribs such as the rear-end first ribs 104A (FIGS. 4A and 4B) can be accommodated in this step part (space above the second bottom portion).

In this embodiment, the supporting projection 115 is a projection projecting toward the bottom surface (underside) of the lift plate 111 from the second bottom portion 110T2. The supporting projection 115 is a projection extending in the lateral direction while having a slight thickness in the front-back direction. Further, as shown in FIG. 7, an upper end part of the supporting projection 115 has an arc shape. Furthermore, with reference to FIG. 4, a pair of the supporting projections 115 are arranged inwardly of the pair of cassette shaft supporting portions 110P in the sheet width direction perpendicular to the conveying direction of the sheets P.

By including such supporting projections 115, the supporting projections 115 come into contact with the underside of the lift plate 111 and support the lift plate 111 from below when the lift plate 111 is arranged at the bottom position. Thus, the concentration of the weight of the sheet bundle on the cassette shaft supporting portions 110P can be prevented. Thus, the deformation of the cassette bottom portion 110T and the cassette rear wall 110B and an increase of a moving load of the lift plate 111 are suppressed. The lift plate 111 can be supported by the simply configured supporting projections 115 projecting from the cassette bottom portion 110T.

When the lift plate 111 is arranged at the bottom position, the upper surface part of the lift plate 111 and that of the first bottom portion 110T1 are substantially flush with each other. The supporting projections 115 project toward the underside of the lift plate 111 from the second bottom portion 110T2. According to such a configuration, the upstream sides of the sheets P in the conveying direction are stably supported by the first bottom portion 110T1 when the lift plate 111 is arranged at the bottom position. On the other hand, the lift plate 111 is stably supported by the supporting projections 115 projecting from the second bottom portion 110T2.

Note that, when the lift plate 111 is arranged at the bottom position and the supporting projections 115 are in contact with the lift plate 111, the inner peripheral parts of the standing wall portions 105 may be in contact with the curved supporting portions 110B2 (FIG. 6) or may be slightly lifted up from the curved supporting portions 102B2. In the former case, the weight of the sheet bundle can be borne at four positions (the pair of cassette shaft supporting portions 110P and the pair of supporting projections 115). On the other hand, in the latter case, the load applied to the cassette shaft supporting portions 110P can be more reduced.

Further, with reference to FIGS. 4 and 7, the supporting projections 115 are arranged downstream of the cassette shaft supporting portions 110P in the conveying direction of the sheets P. Thus, the supporting projections 115 can reliably support the lift plate 111 when the lift plate 111, whose downstream side in the conveying direction vertically moves, is arranged at the bottom position. Further, the interference of the supporting projections 115 with the rear-end first ribs 104A (FIG. 5B) and the like is prevented.

Further, with reference to FIG. 4, the pair of supporting projections 115 are arranged across a center line CL passing through a midpoint of a line segment connecting the pair of cassette shaft supporting portions 110P and extending in the conveying direction of the sheets P while being spaced apart in the sheet width direction (front-back direction). The pair of supporting projections 115 are arranged at positions closer to the cassette shaft supporting portions 110P than to the center line CL. According to such a configuration, the application of the weight of the sheet bundle to the vicinity of the center line CL of the cassette bottom portion 110T is suppressed as compared to the case where the pair of supporting projections 115 are arranged at positions closer to the center line CL than to the cassette shaft supporting portions 110P. Thus, the deflection of the cassette bottom portion 110T due to the weight of the sheet bundle is suppressed.

The sheet cassette 110 and the image forming apparatus 1 according to the embodiment of the present disclosure have been described above. According to such configurations, the deformation of the sheet cassette 110 and an increase of a moving load of the lift plate 111 can be suppressed and an image can be stably formed on the sheet P. Note that the present disclosure is not limited to this and, for example, the following modifications can be adopted.

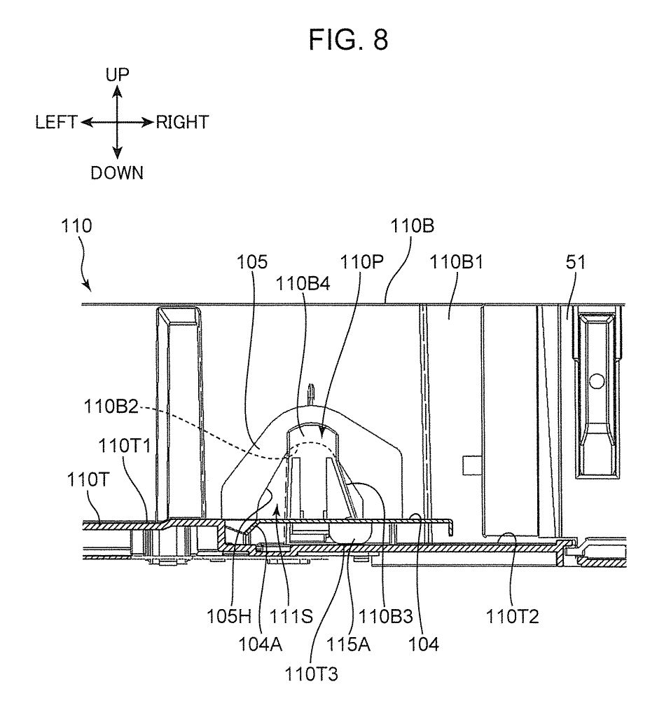

Although the supporting projections 115 project upward from the cassette bottom portion 110T in the above embodiment, the present disclosure is not limited to this. FIG. 8 is an enlarged side view of a part of a sheet cassette according to a modification of the present disclosure. Contrary to the above embodiment, the lift plate 111 may include projections 115A projecting toward the cassette bottom portion 110T (second bottom portion 110T2) as shown in FIG. 8. In this case, areas 110T3 of the second bottom portion 110T2 with which the projections 115A come into contact function as auxiliary supporting portions at the bottom position of the lift plate 111. Also in such a configuration, the lift plate 111 arranged at the bottom position is stably supported by the contact of the projections 115A projecting from the lift plate 111 with the second bottom portion 110T2. Further, since parts of the second bottom portion 110T2 located below the projections 115A can be flat surfaces, the need of the second bottom portion 110T2 to have a complicated shape is suppressed. Further, it is not limited to arrange the supporting projections 115, 115A at two positions. The supporting projection(s) 115, 115A may be arranged at one, three or more positions.

Although the present disclosure has been fully described by way of example with reference to the accompanying drawings, it is to be understood that various changes and modifications will be apparent to those skilled in the art. Therefore, unless otherwise such changes and modifications depart from the scope of the present disclosure hereinafter defined, they should be construed as being included therein.

1. A sheet cassette, comprising:
a bottom portion;
a pair of side walls standing from the bottom portion to face each other;
a lift plate arranged on the bottom portion and configured such that a sheet to be fed in a conveying direction along the side walls is placed on the upper surface of the lift plate; and
at least one auxiliary supporting portion,
wherein:
the lift plate includes a pair of fulcrum portions respectively arranged on an upstream side in the conveying direction and supported on the side walls so that the downstream side of the lift plate moves swingably in the vertical direction with the fulcrum portion and is moved to a sheet feeding position for feeding the sheet moved upwardly from a bottom position where the lift plate extends along the bottom portion; and
the auxiliary supporting portion is arranged inwardly of the pair of fulcrum portions in a sheet width direction perpendicular to the conveying direction, is arranged between the lift plate at the bottom position and the bottom portion and supports the lift plate.

2. A sheet cassette according to claim 1, wherein:
the at least one auxiliary supporting portion is arranged downstream of the fulcrum portions in the conveying direction.

3. A sheet cassette according to claim 1, wherein:
the at least one auxiliary supporting portion includes a pair of the auxiliary supporting portions, the pair of the auxiliary supporting portions being arranged across a center line passing through a midpoint of a line segment connecting the pair of fulcrum portions and extending in the conveying direction in a way that the pair of the auxiliary supporting portions are spaced apart in the sheet width direction; and
the pair of the auxiliary supporting portions are arranged at positions closer to the fulcrum portions than to the center line.

4. A sheet cassette according to claim 1, wherein:
the auxiliary supporting portion is a projection projecting toward the underside of the lift plate from the bottom portion.

5. A sheet cassette according to claim 4, wherein:
the bottom portion includes a first bottom portion arranged on an upstream side than the pair of the fulcrum portions in the conveying direction and a second bottom portion arranged to be lower than the first bottom portion via a step on a side downstream of the first bottom portion in the conveying direction, the lift plate being located on the second bottom portion;
an upper surface part of the lift plate and that of the first bottom portion are substantially flush with each other when the lift plate is arranged at the bottom position; and
the auxiliary supporting portion projects toward the underside of the lift plate from the second bottom portion.

6. A sheet cassette according to claim 1, wherein:
the lift plate includes a projection projecting toward the bottom portion; and
the auxiliary supporting portion comes into contact with the projection at the bottom position of the lift plate.

7. A sheet cassette according to claim 1, wherein:
the bottom portion and the pair of side walls are formed of an integral structure made of resin and the lift plate is made of an metal plate.

8. A sheet cassette according to claim 5, wherein:
the lift plate includes a pair of planar portions having the pair of the fulcrum portions at both ends in the sheet conveying direction and a rib projecting downward from an end part of the planar portion, the end part extending in a sheet width direction;
the auxiliary supporting portion is arranged on the second bottom portion; and
the auxiliary supporting portion comes into contact with the underside of the lift plate and the lift plate with the rib is accommodated in a space above the second bottom portion formed by the step when the lift plate is arranged at the bottom position.

9. An imaging forming apparatus, comprising:
a sheet cassette according to claim 1; and
an imaging forming unit for forming an image on the sheet fed from the sheet cassette.
